(19) United States
(12) Patent Application Publication
(10) Pub. No.: US 2009/0198039 A1
(43) Pub. Date: Aug. 6, 2009

(54) PROCESS FOR THE PREPARATION OF A POLYMER HAVING IMPROVED DYEABILITY

(76) Inventors: Hendrik J. Berg Van Den, Oirsbeek (NL); Albert A. Geenen,Van, Sittard (NL)

Correspondence Address: NIXON & VANDERHYE, PC, 901 NORTH GLEBE ROAD, 11TH FLOOR, ARLINGTON, VA, 22203, US

(21) Appl. No.: 12/091,342

(22) PCT Filed: Nov. 16, 2006
(86) PCT No.: PCT/EP2006/010992

§ 371 Date: Dec. 29, 2008

(30) Foreign Application Priority Data
Nov. 17, 2005 (EP) 05077616.0

(51) Int. Cl. C08G 69/16

(52) U.S. Cl. 528/314

(57) ABSTRACT

Process for the preparation of a polymer comprising the polymerisation of corresponding monomers in the presence of a triazine compound of the formula

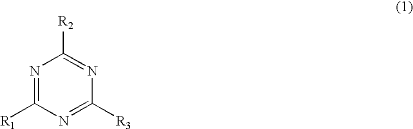

where R₁=-A-B
   where
      A=—O— or —NR₄—,
      B=amino group-containing substituent and
      R₄=hydrogen or alkyl group
   R₂=

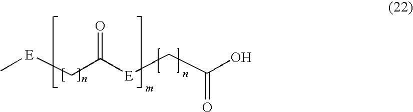

where
   E=—O— or —NR₅—,
   n=3 to 15,
   m=0 to 10 and
   R₅ hydrogen or alkyl group
R₃=R₁, R₂, —OR₆ or —NR₇R₈
where R₆, R₇ and R₈=hydrogen, alkyl or aryl group, which in each case may be substituted or non-substituted.

The invention relates to a process for the preparation of a polymer having improved dyeability and good spinnability properties and to a polymer having these favourable properties.

Processes to produce spinnable polymer grades are known in the art, e.g. for polymers like polyamides and polyesters. Prerequisite for such grades are good spinnability, i.e. the grades can be spun in a continuous, uninterrupted high speed spinning process, and good dyeability since the fibres obtained are often used in clothing or floor coverings.

In the spinning process the polymer is heated and molten bringing as an unwanted effect polycondensation of the polymer, resulting in viscosity increase that may cause irregular spinning and fibre breakage. To prevent this polycondensation, e.g. in polyamides a low number of amine end groups in the polymer is favourable. At the same time the presence of amine end groups enhances the dyeability of the polymer. This imposes conflicting requirements to the polymer.

The invention now aims at a process, producing a polymer that has reduced tendency to polycondensation, and still has good dyeability properties.

This aim is achieved in that the process comprises the polymerisation of corresponding monomers in the presence of a triazine compound of the formula

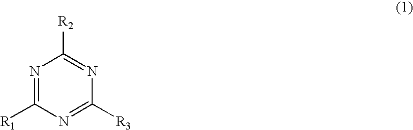

where R₁=-A-B
where
   A=—O— or —NR₄—,
   B=amino group-containing substituent and
   R₄=hydrogen or alkyl group
R₂

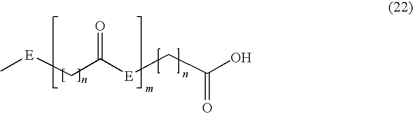

where
   E=—O— or —NR₅—,
   n=3 to 15,
   m=0 to 10 and
   R₅=hydrogen or alkyl group
R₃=R₁, R₂, —OR₈ or —NR₇R₈
where R₆, R₇ and R₈=hydrogen, alkyl or aryl group, which in each case may be substituted or non-substituted.

These triazine compounds conforming to the formula (1) can be produced by reacting cyanuric chloride with 0.5 to 5 mole equivalents of an amine of the formula (2)

H-A-B (2)

in the presence of a base and of 0.5 to 5 mole equivalents of a compound conforming to the formula (3)

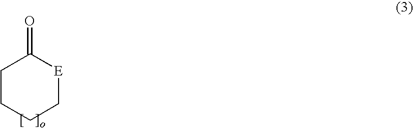

or of a compound conforming to the formula (4)

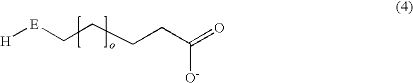

where
o is from 0 to 12,
E=—O— or —NR₅— and
R₅=hydrogen or alkyl group,

and the two reaction steps may be carried out in either order.

We have found, surprisingly, that triazine compounds substituted by substituents containing both amino and carboxyl groups are useful as reactive stabilizers for polyesters and polyamides. Reactive stabilizers for the purposes of this invention are capable of being incorporated in the polymer, through their amino- and carboxyl-containing substituents, and hence are a building block in the polymer chain. This has the advantage over prior art stabilizers that the stabilizers of the present invention can be added at the polymerisation stage and become incorporated in the polymer chain in the course of the polymerisation. There is thus no need for an additional step of admixing the stabilizer to the polymer. These stabilizers of the present invention further have the advantage that they cannot be dissolved out of the polymer and thus a permanently effective stabilizer is available. The achievement of the object was all the more surprising since it has been determined that these compounds can be prepared by an economical process.

The triazine compounds that can be used in the present invention have a structure, which conforms to the formula (1)

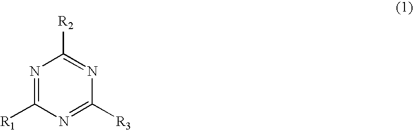

where R₁=-A-B
where
   A=—O— or —NR₄—,
   B=amino group-containing substituent and
   R₄=hydrogen or alkyl group
R₂

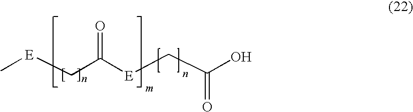

where
   E=—O— or —NR₅—,
   n=3 to 15,
   m 0 to 10 and
   R₅=hydrogen or alkyl group
R₃=R₁, R₂, —OR₆ or —NR₇R₈
where R₆, R₇ and R₈=hydrogen, alkyl or aryl group, which in each case may be substituted or non-substituted.

The structural fragment A in the substituent of type R₁ of the triazine compounds may be not only —O— but also —NR₄—, and the structural fragment A in the substituents of types R₁ and R₃ may be the same or different. Preferably, the structural fragment A is —NR₄—. The substituent of type R₄ may be not only hydrogen but also an alkyl group. Preferably, the substituent of type R₄ is hydrogen or an alkyl group having from 1 to 10 and preferably from 2 to 5 carbon atoms. This alkyl group of the substituent of type R₄ may be branched or unbranched, but preferably it is unbranched. Furthermore, this alkyl group is preferably unsubstituted. More preferably, however, the substituent of type R₄ is hydrogen.

The substituent of type B is in particular an amino group-containing substituent in which the amino group may be situated on an aliphatic supporting scaffold or may be an aliphatic cyclic amine. Preferably, the substituent of type B comprises an aliphatic cyclic amine.

Preferably, the triazine compounds that can be used in the present invention comprise a substituent of type B that conforms to the formula (5)

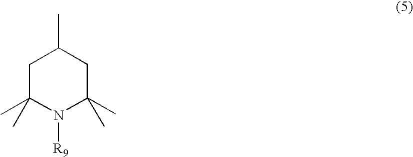

where R₉=hydrogen, an alkyl or an alkoxy group of the formula —O—R₂₀,

R₂₀=a branched or unbranched alkyl or cycloalkyl group having in either case from 4 to 16 carbon atoms,

or which conforms to the formula (6)

—(CH₂)ₚ—NR₁₀R₁₁ (6)

where p is from 1 to 15, preferably from 2 to 8 and more preferably from 3 to 6,

in the substituent of type R₁,

The substituents of types R₁₀ and RP7 may be the same or different and are preferably hydrogen, an alkyl, a cycloalkyl or a heterocycloalkyl group, in particular having in each case from 1 to 20 and preferably from 2 to 10 carbon atoms or from 1 to 20 and preferably from 2 to 10 carbon and hetero atoms. This alkyl group of the substituents of types R₁₀ and R₁₁ are preferably branched or unbranched, but more preferably they are unbranched. Furthermore, they are preferably unsubstituted or substituted by an amino group, but more preferably it is unsubstituted. The cycloalkyl group of the substituents of types R₁₀ and R₁₁ is preferably unsubstituted or substituted; in particular this cycloalkyl group is unsubstituted. The heterocycloalkyl group of the substituents of types R₁₀ and R₁₁ is preferably unsubstituted or substituted, preferably this heterocycloalkyl group is substituted by one or more methyl groups, preferably it is a heterocycloalkyl group which comprises one or more nitrogen atoms as a hetero atom, preferably it is a heterocycloalkyl group which conforms to the formula (5).

The substituent of type R₉ is preferably hydrogen or an alkyl group having from 1 to 16 and preferably from 1 to 8 carbon atoms or an alkoxy group having a branched or unbranched alkyl group or a cycloalkyl group; more preferably, the substituent of type R₉ is hydrogen.

Preferably, the triazine compounds comprise a substituent of type B, which conforms to the formula (6). More preferably, the triazine compounds comprise a substituent of type B, which conforms to the formula (6a):or (6b):

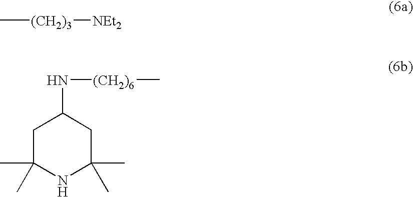

In a particularly preferred embodiment of the triazine compounds, these comprise a substituent of type B, which conforms to the formula (5).

Very particular preference is given to triazine compounds comprising a substituent of type R₁ that conforms to the formula (7):

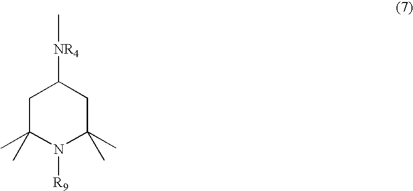

The substituents of type R₂ in the triazine compounds preferably comprise a structural fragment E with —O— or —NR₅—, the substituent of type R₅ preferably being hydrogen or an alkyl group having from 1 to 16 and preferably from 1 to 4 carbon atoms; preferably, the substituent of type R₅ is hydrogen, The alkyl group of the substituent of type R₅ is branched or unbranched, but preferably it is unbranched. Further this alkyl group of the substituent of type R₅ is preferably unsubstituted. In the substituent of type R₂ n is preferably in the range from 3 to 15, more preferably in the range from 5 to 11 and even more preferably 5 and m is preferably in the range from 0 to 10, more preferably in the range from 0 to 4 and even more preferably m is equal to 0.

The triazine compounds for use in the present invention preferably comprise a substituent of type R₁ as substituent of type R₃. In a particular embodiment, the triazine compounds comprise a substituent of type R₂ as substituent of type R₃. The two substituents of types R₁ and R₂ may be respectively identical or different; preferably, the substituents of the same type are identical.

In a preferred embodiment, the triazine compounds comprise a substituent of type R₁ which conforms to the following structures (7a), (7b) or (7c):

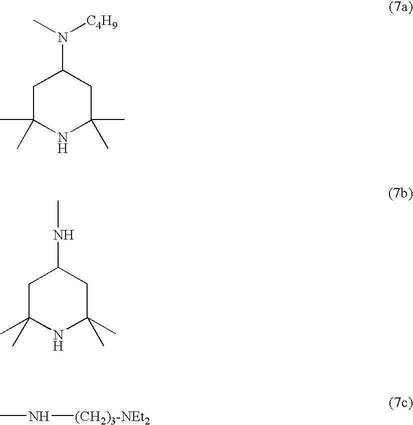

The substituents of type R₂ in this preferred embodiment have in particular structures conforming to the formula (8a) or (8b):

—NH—(CH₂)₅—COOOH (8a)

—NH—(CH₂)₁₋₁—COOH (8b)

In this preferred embodiment, the substituent of type R₃ is preferably a substituent of type R₁ and more preferably these two substituents are identical. In this preferred embodiment the substituent of type R₃ may also be a substituent of type R₂ and again these two substituents are preferably identical,

In a further embodiment of the triazine compounds, these comprise a substituent of type R₃ which conforms to the following formulae (14) and (15):

—O—R₆ (14)

or

—NR₇R₈ (15)

where R₆, R₇ and R₈ is hydrogen, alkyl group or aryl group, the alkyl or aryl group being unsubstituted or substituted by one or more substituents of the formulae R₆, R₇, R₅, —SO₃H or —SO₃M, where M is an alkali metal cation, preferably a lithium, sodium or potassium cation. The alkyl and/or aryl groups of the substituents of type R₆, R₇ or R₈ preferably comprise from 1 to 4 substituents, more preferably from 1 to 2 substituents and most preferably one substituent of the formula —SO₃H or —SO₃M. Preferably, the substituents of types R₆, R₇ and R₈ are hydrogen or an alkyl group having from 1 to 18 and preferably from 2 to 16 carbon atoms. This alkyl group of the substituents of types R₆, R₇ and R₅ may be branched or unbranched, but preferably it is unbranched. The aryl group of the substituents of types R₆, R₇ and R₈ is preferably a phenyl group or a phenyl group which is substituted, preferably in the para position, by —SO₃H or —SO₃M. The substituents of types R₆, R₇ and R₈ may be all identical, all different or else form identical pairs. Preferably, the substituents of types R₆, R₇ and R₈ are hydrogen, a phenyl group or a phenyl group substituted by —SO₃H or —SO₃M in the para position.

The process for preparing triazine compounds conforming to the formula (1),

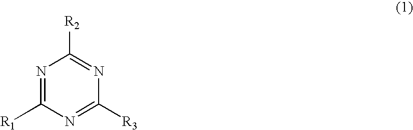

where R₁=-A-B
where
   A=—O— or —NR₄—,
   B=amino group-containing substituent and
   R₄=hydrogen or alkyl group
R₂=

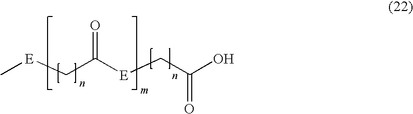

where
   E=—O— or —NR₅—,
   n=3 to 15,
   m=0 to 10 and
   R₅=hydrogen or alkyl group
R₃═R₁, R₂, —OR or —NR₇R₈
where R₆, R₇ and R₈=hydrogen, alkyl group or aryl group, which in each case may be substituted or non-substituted, comprises reacting cyanuric chloride with 0.5 to 5 mole equivalents of an amine of the formula (2)

H-A-B (2)

in the presence of a base and of 0.5 to 5 mole equivalents of a compound conforming to the formula (3)

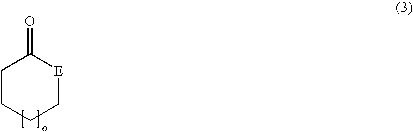

or of a compound conforming to the formula (4)

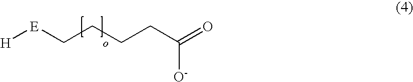

where
o is from 0 to 12,
E=—O— or —NR₅— and
R₅=hydrogen or alkyl group,
   and the two reaction steps may be carried out in either order.
   In the embodiment of the process in which compounds having R₃ other than R₁ or R₂ are prepared, 0.5 to 5 mole equivalents of a compound conforming to the formula (16) or (17)

H—OR₆ (16)

or

H—NR₇R₈ (17)

are reacted in the presence of a base in a further process step.

The substituent of type R₅ may be not only hydrogen but also an alkyl group. Preferably, the substituent of type R₅ is hydrogen or an alkyl group having from 1 to 16 and preferably from 1 to 4 carbon atoms. This alkyl group of the substituent of type R₅ may be branched or unbranched but is preferably unbranched. Further this alkyl group of the substituent of type R₅ is preferably unsubstituted. Preferably, however, R₅ is hydrogen. In the compounds according to the formula (3) or (4) o is preferably from 0 to 12, more preferably from 2 to 8 and with particular preference 2.

The process preferably utilizes lactams or lactones as compounds conforming to the formula (3), more preferably however lactams are utilized, It is particularly preferable for caprolactam to be used in the process. One particular embodiment of the process utilizes a compound, which conforms to the formula (4), more preferably sodium aminocaproate.

The reactant conforming to the formula (4) may also be formed in situ in the process, for example through the use of a compound conforming to the formula (3) and a base, in particular a alkali hydroxide, for example sodium hydroxide. The substance ratio in which the two reactants are used for this is preferably in the range from 5:1 to 1:1, preferably in the range from 4:1 to 1:1 and more preferably 2:1 to 11′.

The process utilizes from 0.5 to 5, preferably from 1 to 3 and more preferably from 1 to 2 mole equivalents of the compound conforming to the formula (3) or (4) based on the cyanuric chloride used.

The process preferably utilizes as a further reactant an amine conforming to the formula (2), and the structural fragment A may be not only —O— but also —NR₄—. Preference is given to using an amine, which conforms to the formula (2) and comprises —NR₄— as structural fragment A. The substituent of type R₄ may be not only hydrogen but also an alkyl group. Preferably the substituent of type R₄ is hydrogen or an alkyl group having from 1 to 10 and preferably from 2 to 5 carbon atoms. This alkyl group of the structural fragment A may be branched or unbranched, but preferably it is unbranched. Furthermore, this alkyl group is preferably unsubstituted. More preferably, however, the R₄ substituent is hydrogen.

The process utilizes an amine of the formula (2) where the substituent of type B is preferably an amino group-containing substituent in which the amino group may be situated on an aliphatic supporting scaffold or may be an aliphatic cyclic amine. Preferably, this substituent of type B comprises an aliphatic cyclic amine.

The process preferably utilizes amines of the formula (2) which comprise a substituent of type B according to the formula (6) or the formula (5).

The substituents of types R₁₀ and R₁₁ may be the same or different and are preferably hydrogen, an alkyl, a cycloalkyl or a heterocycloalkyl group, having in each case from 1 to 20 and preferably from 2 to 10 carbon atoms or from 1 to 20 and preferably from 2 to 10 carbon and hetero atoms. This alkyl group of the substituents of types R₁₀ and R₁₁ are preferably branched or unbranched, but more preferably they are unbranched. Furthermore, they are preferably unsubstituted or substituted by an amino group, but more preferably it is unsubstituted. The cycloalkyl group of the substituents of types R₁₀ and R₁₁ is preferably unsubstituted or substituted; in particular this cycloalkyl group is unsubstituted. The heterocycloalkyl group of the substituents of types R₁₀ and R₁₁ is preferably unsubstituted or substituted, preferably this heterocycloalkyl group is substituted by one or more methyl groups, preferably it is a heterocycloalkyl group which comprises one or more nitrogen atoms as a hetero atom, preferably it is a heterocycloalkyl group which conforms to the formula (5).

The substituent of type R₉ is preferably hydrogen or an alkyl group having from 1 to 16 and preferably from 1 to 8 carbon atoms or an alkoxy group comprising a branched or unbranched alkyl group or a cycloalkyl group, more preferably, the substituent of type R₉ is hydrogen.

The process preferably utilizes amines having a substituent of type B, which conforms to the formula (6). However, it is particularly preferable to utilize amines having a substituent of type B which conforms to the formula (6a) or (6b). Very particular preference is given to utilizing amines conforming to the formula (2a)

HNR₄—(CH₂)ₘ—NR₁₀R₁₁ (2a).

One particularly preferred embodiment of the process utilizes amines comprising a substituent of type B conforming to the formula (5). It is very particularly preferable to utilize amines conforming to the formula (2b):

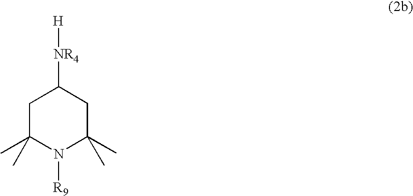

in the process.

The process may also utilize mixtures of different compounds conforming to the formulae (3) or (4) or else mixtures of different amines conforming to the formula (2).

A further embodiment of the process utilizes, as a further reactant, compounds conforming to the formula (16) or (17), where R₆, R₇ and R₈ are each hydrogen, alkyl group or aryl group, the alkyl or aryl group being unsubstituted or substituted by one or more substituents of the formula R₆, R₇, R₈, —SO₃H or —SO₃M, where M is an alkali metal cation, preferably a lithium, sodium or potassium cation. The alkyl and/or aryl groups of the substituents of types R₆, R₇ or R₅ preferably comprise from 1 to 4 substituents, more preferably from 1 to 2 substituents, and most preferably one substituent of the formula —SO₃H or —SO₃M. Preferably, the substituents of types R₆, R₇ and R₈ are hydrogen or an alkyl group having from 1 to 18 and preferably from 2 to 16 carbon atoms. This alkyl group of the substituent of types R₆, R₇ and R₈ may be branched or unbranched; preferably, it is unbranched. The aryl group of the substituents of types R₆, R₇ and R₈ is preferably an unsubstituted phenyl group or a phenyl group which is monosubstituted, preferably in the para position, by —SO₃H or —SO₃M. The substituents of types R₆, R₇ and R₈ may be all identical, all different or else form identical pairs. Preferably, the substituents of types R₅, R₇ and R₈ are hydrogen, a phenyl group or a phenyl group which is monosubstituted by —SO₃H or —SO₃M in the para position.

Depending on the triazine compound to be prepared, the reaction may consist of two or three steps for the actual conversion or reaction.

One preferred embodiment of the process comprises reacting cyanuric chloride with an amine conforming to the formula (2) in the presence of a base in a solvent in a first step. Aqueous sodium hydroxide solution is preferably used as base. Amine and base are preferably used in a substance ratio of 1:1. This first reaction step of this preferred embodiment may utilize a solvent selected from water, aromatic hydrocarbons, in particular toluene, xylene, alkanes, ethers, ketones, such as acetone for example, or esters; water is preferably used as solvent. Alcohols, primary or secondary amines are unsuitable as solvents for this first reaction step. The second process step then comprises the reaction with a compound selected from compounds conforming to the formula (3) or (4).

A further embodiment of the process comprises a first step in which cyanuric chloride is reacted with a compound selected from compounds conforming to the formula (3) or (4) and subsequently, in a further reaction step, with an amine conforming to the formula (2). The solvent and the substance ratio of amine to base may be chosen similarly to the preferred embodiment.

The reaction step involving a compound conforming to the formula (3) as a reactant is preferably carried out in the presence of a ring-opening base. In particular water, toluene, xylene, alkanes, ethers, ketones, such as acetone for example, or esters, but preferably water are used here as solvent. One particular embodiment of the process utilizes a lactam as solvent, more particularly a compound conforming to the formula (3) is used as solvent, and it is more preferable to utilize the same compound as solvent and as reactant. However, when a compound conforming to the formula (4) is utilized as a reactant in a reaction step, the reaction step is carried out in the presence of an excess of the corresponding compound conforming to the formula (3), meaning a substance ratio of compound conforming to the formula (3) to cyanuric chloride which is preferably 1:4 and in particular 1.1:3.5. For example, when as a reactant use is made of sodium aminocaproate as a compound conforming to formula (4), the reaction is carried out in the presence of an excess of caprolactam.

When the process is used for preparing triazine compounds conforming to the formula (1) where R₃═R₁ or R₂, it comprises a first step in which the cyanuric chloride is preferably reacted with from 0.5 to 3 and more preferably from 1 to 2 mole equivalents based on the amount of cyanuric chloride of reactant A, reactant A being either an amine conforming to the formula (2) or a compound selected from compounds conforming to the formula (3) or (4). In a second reaction step, the intermediate obtained is then reacted with from 0.5 to 5 and preferably from l to 4 mole equivalents based on the amount of cyanuric chloride of reactant B, reactant B being
a compound selected from the compounds conforming to the formula (3) or (4) when an amine conforming to the formula (2) is used as reactant A, or
an amine conforming to the formula (2) when a compound selected from compounds conforming to the formula (3) or (4) is used as reactant A.

The temperature at which the first reaction step is carried out is preferably in the range from −20 to 100° C., more preferably in the range from −10 to 80° C. and even more preferably in the range from 0 to 60° C. By contrast, the temperature at which the second reaction step is carried out is preferably in the range from 0 to 200° C., more preferably in the range from 10 to 180° C. and even more preferably in the range from 20 to 170° C. In one embodiment of the process in which only one chlorine atom of the cyanuric chloride is reacted with reactant A in the first step and the two remaining chlorine atoms of the cyanuric chloride are reacted with reactant B in a second step, it is advantageous to employ a temperature ramp in the second step.

The pressure at which the first reaction step is carried out is preferably from 0.5 to 1.5 bars, more preferably from 0.8 to 1.2 bars and even more preferably atmospheric pressure. By contrast, the pressure at which the second reaction step is carried out is preferably from 1 to 11 bar, more preferably from 1 to 9 bar and even more preferably from 1 to 8 bar.

A further embodiment of the process comprises a first reaction step in which cyanuric chloride is reacted with a compound selected from compounds conforming to the formula (3) or (4) in a solvent. The reaction with an amine conforming to the formula (2) is then carried out in the second reaction step.

In one preferred embodiment of the process, the first reaction step comprises reacting the cyanuric chloride with from 1 to 3 mole equivalents and preferably with 2 mole equivalents based on the amount of cyanuric chloride of reactant A and a second step which then comprises reacting the resulting intermediate with 0.5 to 5 and preferably from 1 to 3 mole equivalents based on the amount of cyanuric chloride of reactant B, The temperature at which the first step is carried out is preferably from 0 to 100° C., more preferably from 10 to 80° C. and even more preferably from 20 to 60° C. By contrast, the temperature at which the second step is carried out is preferably from 80 to 200° C., more preferably from 90 to 180° C. and even more preferably from 100 to 170° C.

When the process is used for preparing triazine compounds conforming to the formula (1) where R₃=—OR₆ or —NR₇R₈, then the process comprises a first reaction step where cyanuric chloride is reacted with from 0.5 to 2 mole equivalents and preferably 1 mole equivalent based on the amount of cyanuric chloride of reactant A, reactant A being either an amine conforming to the formula (2) or a compound selected from compounds conforming to the formula (3) or (4), or a hydroxy or amino compound of the formula (16) or (17). In a second reaction step, the intermediate obtained is then reacted with from 0.5 to 2 mole equivalents and preferably with 1 mole equivalent based on the amount of cyanuric chloride of reactant B, reactant B being
a compound selected from compounds conforming to the formulae (3), (4), (16) or (17) when a compound of the formula (2) is used as reactant A, or
a compound selected from compounds conforming to the formula (2), (16) or (17) when a compound selected from the compounds conforming to the formula (3) or (4) is used as reactant A, or
a compound selected from compounds conforming to the formula (2), (3) or (4) when a compound selected from compounds conforming to the formula (16) or (17) is used as reactant A,

In a third reaction step of this particular embodiment of the process, the intermediate obtained is then reacted with from 0.5 to 2 mole equivalents and preferably with 1 mole equivalent based on the amount of cyanuric chloride of reactant C, reactant C being
a compound selected from compounds conforming to the formula (16) or (17) when compounds of the formula (2) and (3) or (4) are used as reactants A and B, or
a compound selected from compounds conforming to the formula (3) or (4) when compounds of the formula (3) or (4) and (16) or (17) are used as reactants A and B, or
a compound conforming to the formula (2) when compounds of the formula (3) or (4) and (16) or (17) are used as reactants A and B.

The temperature at which the first reaction step of this particular embodiment of the process is carried out is preferably from −20 to 80° C., more preferably from −10 to 60° C. and even more preferably from 0 to 40° C. The temperature at which the second step is carried out is by contrast preferably from 0 to 100° C., more preferably from 10 to 80° C. and even more preferably from 20 to 60° C. The temperature at which the third step is carried out is preferably from 80 to 200° C., more preferably from 90 to 180° C. and even more preferably from 100 to 170° C.

The pressure at which the first and second reaction steps of this particular embodiment of the process are carried out is preferably from 0.5 to 1.5 bar, more preferably from 0.8 to 1.2 bars and even more preferably atmospheric pressure. The pressure at which the third step is carried out is by contrast preferably from 1 to 11 bar, more preferably from 1 to 9 and even more preferably from 1 to 8 bars. The individual reaction steps of the process of the present invention can be carried out in any one stage of the process of the present invention, it being possible to separate and isolate the intermediates which are formed in each case so that they can be used as a starting material for the next stage.

In one particular embodiment, the intermediates of a stage are not separated off and isolated—with the exception of the last stage—but are directly fed as a starting material to the next stage. In this embodiment of the process of the present invention, the intermediates are thus formed in situ.

In a further embodiment of the process of the present invention, all reaction steps are carried out in one reaction apparatus, in particular in an autoclave. In this embodiment, the reaction of the compounds of the formula (3) with a base can be carried out in a separate stage or in a separate reaction vessel. However, the reaction of the compounds conforming to the formula (3) with a base can also be carried out in the same reaction vessel, so that all reaction steps of the process of the present invention take place in the same reaction vessel. In this way, all three substitutions on the triazine ring of the process of the present invention can be carried out in one reaction vessel.

In general, the reaction of the compounds conforming to the formula (3) with a base can take place in a separate stage or reaction vessel. However, the reaction of the compounds conforming to the formula (3) with a base can also take place in the same reaction vessel in which the respective reaction stage is just taking place.

The working-up of the reaction mixture chiefly serves to remove the by-product sodium chloride. With the water-insoluble triazine compounds, the sodium chloride is dissolved in water and removed by filtering the aqueous suspension and subsequently washing the filter cake or by extracting the target product with an organic solvent, preferably with the organic solvent employed during the reaction, With the water-soluble triazine compounds, the likewise water-soluble sodium chloride is preferably removed by electrodialysis via a membrane or ion exchange chromatography; the sodium chloride is preferably removed by ion exchange chromatography.

The reaction mixture thus worked up, which constitutes a solution in water or in an organic solvent, can then be used directly; in one particular embodiment the use as a stabilizer is preceded by a drying operation.

The intermediates arising after the individual reaction steps may in one particular embodiment of the process be isolated from the reaction mixture and purified. This is preferably accomplished by crystallization, filtration and if appropriate a wash from the reaction mixture. The isolation and purification of these intermediates can also be effected by means of an extraction with an organic solvent, preferably with the organic solvent already employed during the reaction. The intermediates thus isolated and purified are generally solids and can then be employed in the next step of the process.

In further embodiment of the process, these intermediates are not isolated and worked up. The reaction steps are carried out in succession without the intermediates being isolated and worked up, In the process, as the triazine compound also a mixed composition, comprising at least two different triazine compounds conforming to the formula (1) can be used. This mixed composition then preferably comprises
85% to 95% by weight of triazine compounds conforming to the formula (18),

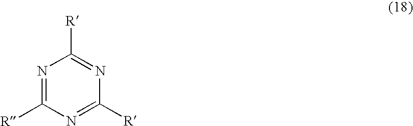

0% to 10% by weight of triazine compounds conforming to the formula (19),

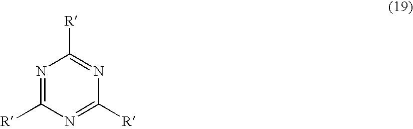

0% to 10% by weight of triazine compounds conforming to the formula (20)

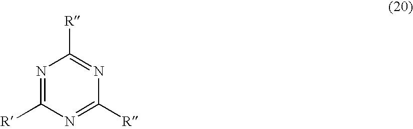

where R′=R₁ or R₂ and R″ R₂ or R₁ and R′ is not identical to R″, meaning in particular that when R′=R₁, then R″=R₂, and vice versa.

In one preferred embodiment of this mixed composition R′=R₁ and R″=R₂. This composition is obtainable on using the reactants cyanuric chloride, amine of the formula (2) and a compound conforming to the formula (3) or (4) in a substance ratio of 1:2:1 in the process.

In one particularly preferred embodiment of the mixed composition R′=R₁ and R″=R₂. This composition is obtainable on using the reactants cyanuric chloride, amine of the formula (2) and a compound conforming to the formula (3) or (4) in a substance ratio of 1:1:2.

A further embodiment of a mixed composition comprises
30% to 95% by weight of triazine compounds conforming to the formula (18),

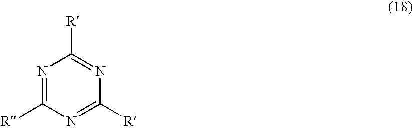

0% to 60% by weight of triazine compounds conforming to the formula (20),

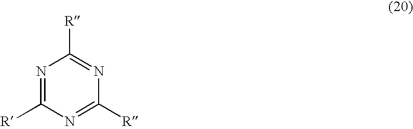

0% to 10% by weight of triazine compounds conforming to the formulae (19) and (21),

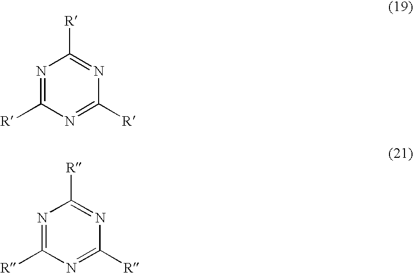

where R′=R₁ or R₂ and R″=R₂ or R₁ and R′ is not identical to R″, meaning in particular that when R′=R₁, then R″=R₂ and vice versa. This composition is obtainable when the reactants cyanuric chloride, amine of the formula (2) and a compound conforming to the formula (3) or (4) are used in a substance ratio of 1:1.5:1.5.

A further preferred embodiment of the composition comprises
60% to 90% by weight of triazine compounds conforming to the formula (23),

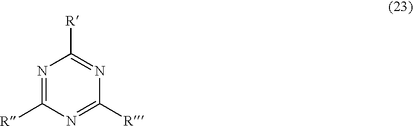

1% to 30% by weight of triazine compounds each having two substituents of the same type and a different third substituent selected from R′, R″ or R′″, for example triazine compounds conforming to the formula (18) or (20),
0.5% to 10% by weight of triazine compounds where all three substituents are of the same type, selected from R′, R″ or R′″, for example triazine compounds conforming to the formula (19) or (21),
   where R′=R₁, R₂ or R₃, R″=R₂, R₁ or R₃ and R′″=R₃, R₂ or R₁ and R′, R″ and R′″ are not identical, meaning in particular that when R′=R₁, then R″=R₂ and R′″=R₃, or vice versa. This composition is obtainable when the reactants cyanuric chloride, amine of the formula (2), a compound conforming to the formula (3) or (4) and a compound conforming to the formula (16) or (17) are used in a substance ratio of 1; (from 0.5 to 2):(from 0.5 to 2):(from 0.5 to 5), preferably in a substance ratio of 1:1:1:(from 1 to 4) in the process.

In the process according to the invention the triazine compound reacts with an amine end group of the polymer chain through the carboxyl moiety thus removing an amine end group from the polymer but at the same time provides one or two non-reactive amine end groups. It has been found that these non-reactive amine end groups do not contribute to the polycondensation but have a comparable effect on the dyeability as reactive end groups do. Thus the dyeability is retained or even enhanced whereas the spinnability properties are enhanced by the reduction of the polycondensation during the spinning process.

In a preferred embodiment R₁ and R₃ are both diamine rest groups bringing the advantage of an even enhanced dyeability.

In a second preferred embodiment R₃ is an amino acid rest group. In this embodiment the triazine compound functions as a diacid and acts as a chain length regulator, which otherwise has to be added separately. The dyeability is retained by the presence of the amine end group of R₁.

In both embodiments B preferably comprises a non-reactive amino end group, which preferably is a hindered amine group, having the advantage that, besides dyeability, it imposes UV-stability to the polymer.

The process for the preparation of the polymer can be the usual polymerising process, starting from the corresponding monomers. Examples of such processes are e.g. described in Ullman's Encyclopedia of Industrial Chemistry, Vol. 21A, Chapters ‘Polyamides’ and ‘Polyesters. For polyamides the usual hydrolytic polymerisation processes can be applied. The process can be both a continuous process and a batch process.

The polymerisation process is conducted under the normal conditions in the presence of the triazine compound. The triazine compound can be added to the starting monomers or it can be added separately to the polymerisation equipment, preferably then in a controlled way during the process. The triazine compound will become chemically bonded to the polymer chain through the carboxyl moiety.

If the polymer is a polyamide the corresponding monomers can be a mixture of suitable diacids and diamines, the corresponding di-acid-diamine salts or lactams. E.g. for polyamide-6 (PA 6) caprolactam is the corresponding monomer, the polymerisation of PA 6,6 usually starts from the salt of hexamethylene diamine and adipic acid. The corresponding starting monomers for further polyamides are well known in the art, Suitable monomers in the process of the invention are those that can polymerise to thermoplastic polyamides, preferably to semi-crystalline polyamides in view of their favourable processing and mechanical properties. Examples of these polyamides include polyamide-6 (PA-6), PA-6,6, PA-4,6, PA-6,9, PA-6,10, PA-11, PA-12, PA-MXD6, and copolymers and mixtures of such polyamides. Preferably the polyamide is a PA 6, PA 66, PA 46 or a copolyamide of the constituting monomers thereof.

If the polymer is a polyester the monomers can be diols and dicarboxylic acid or their polyester-forming derivatives such as dimethyl esters. Suitable diols have the formula HO—R—OH, where R is a divalent, branched or unbranched aliphatic and/or cycloaliphatic radical having 2 to 18 and preferably 2 to 12 carbon atoms. Suitable dicarboxylic acids have the formula HOOC—R′—COOH, where R′ is a divalent aliphatic, cycloaliphatic or aromatic radical having 2 to 18 and preferably 4 to 12 carbon atoms. The preparation of these polyesters is state of the art and is e.g. described in Ullman's Encyclopedia of Industrial Chemistry, Vol. 21A, Chapter ‘Polyesters’.

The triazine compound is present in an amount of at least 2 mmoles/kg, preferably at least 5 mmoles/kg and more preferably at least 10 mmoles/kg. It is also present in amount of at most 70 mmoles/kg, preferably at most 40 mmoles/kg and more preferably at most 30 moles/kg, All said amounts are with respect to the total of the monomers, including any mono- or diamines or -acids, and the triazine compound.

In the process according to the invention mixed compositions of triazines, as defined above, can be applied, giving the opportunity to balance and enhance the combination of the dyeability improving and UV-stabilizing effects.

The polymerisation process can be conducted in the presence of further compounds known for this, e.g. water, chain regulators, of which mono- and di-acids and mono- and diamines are examples, pigments in amounts usual in the a.

The invention further relates to a polymer having good spinnability and dyeability properties, characterized by the presence of a substituted triazine compound being chemically bonded to a polymer chain and having the formula I as defined above.

The polymer according to the invention, due to the presence of the substituted triazine compound, combines good spinnability and good dyeability which makes it particularly suitable for manufacturing fibres suitable for clothing and floor covering.

In a preferred embodiment R₁ and R₃ are both diamines, bringing the advantage of an even enhanced dyeability.

In a second preferred embodiment R₃ is an amino acid. In this embodiment, in particular in lactam based polyamides, the triazine compound will generally be bonded with both carboxyl moieties to a polymer chain and it has been found that in that situation the polymer has a narrower molecular weight distribution Mw/Mn than in the case R₃ is a diamine. This improves rheologic behaviour of the polymer melt and thus favours spinnability. The dyeability is retained by the presence of the amine end group of R₁.

In both embodiments B preferably comprises a non-reactive amino end group, which preferably is a hindered amine group, having the advantage that, besides dyeability, it imposes UV-stability to the polymer.

It was further found that this UV-stability is also present in a composition comprising a polyamide or a polyester further comprising a substituted triazine compound having the formula 1, as defined above.

The invention will be illustrated by the following examples, without being restricted thereto.

### EXAMPLE I POLYMERISATION

To a 20 l Fourné autoclave reactor, preheated at 160° C., a 10 kg mixture consisting of 98 wt % caprolactam, 0.24 wt % benzoic acid, 0.5 wt % of bis-triacetonamino-triazine-aminocaproic acid (BTT-ACA) and 1.26 wt % water were added. With respect to the total mixture the amount of benzoic acid equals 20 mmoles/kg, the amount of BTT-ACA equals 5 mmoles/kg.

The reactor was heated from 160° C. to 260° C. at a rate of 2.5° C. /min. The reactor was kept at that temperature and at a pressure of 4 bars for half an hour as a first polymerisation step. As a next step the pressure was lowered to 1.6 bars and the surplus of water was removed by distillation. The reactor then was kept at 260° C. and 1.6 bars for 5.5 hours.

The reactor contents in a molten state were expelled then from the reactor at a temperature of 250° C. and a pressure of 5.5 bars through a plate containing holes to form strands that were cooled and chopped into granules.

Unreacted caprolactam and other components were extracted from the granules with streaming hot water at 100° C. for 16 hours and at a pressure of 1.1 bars. The sum of extracted compounds amounted to 10 wt %. With respect to the polymer after extraction, the amount of benzoic acid connected to the polymer equals 22.2 mmoles/kg and connected BTT-ACA equals 5.6 mmoles/kg

White granules were obtained of a polymer having a relative viscosity (1% solution in 96% sulphuric acid at 23° C.) of 2.44.

### EXAMPLE II POLYMERISATION

Example I was repeated with the proviso that the benzoic acid was replaced with an equivalent amount, viz. 0.32 wt % being 20 mmoles/kg, of terephtalic acid whereas the amount of water was adapted to arrive at 100 wt % in total. The pressure in the second polymerisation step was 1.94 bar. Further conditions and amounts were unchanged.

White granules were obtained of a polymer having a relative viscosity (1% solution in 96% sulphuric acid at 23° C.) of 2.46.

### EXAMPLE III SPINNING

The polymer granules obtained in Experiments I and II were melt spun at a temperature of 270° C. by heating and melting the granules in an extruder and pressing the melt through a spin plate having 24 orifices of 0.25 mm diameter and taken up on a Barmag SW 46 winder at speeds varying from 4000-6000 m/min. The residence time of the melt at 270° C. was 15 minutes.

The spinning behaviour of the polyamides was excellent as illustrated by their Spinnability Index S defined as:

S=0.1*FC+FB+10*YB,

wherein FC is the number of fray counts, FB is the number of single filament breakages and YB the number of yarn breakages during the spinning process as a function of the wind-up speed (WUS). The values of S ranged from 0.1 to 3, the higher values only occurring with the mono(benzoic-) acid type of polyamide at spinning speeds above 5000 m/mink In general values of S below 10 qualify as ‘excellent spinnability’.

The mechanical properties tenacity, elongation, E-modulus, work-to-rupture (WTR) of the obtained partly oriented yarns (POY) are given in Table 1, both for the monoacid and the diacid (terephtalic acid-) type of polyamide. The partly oriented yarns produced from the monoacid polyamide spun at 4200 m/min were further drawn to fully drawn yarns (FDY) at various drawing ratios. The properties of the fully oriented yarns are given in Table 2. The titre given is that for the 24-filament bundle.

TABLE 1
Mechanical properties BTT_ACA based POY yarns

| WUS | Tenacity [cN/dtex] | | Elongation (%) | | E-modulus [cN/dtex] | | WTR [cN · cm] | |
|---|---|---|---|---|---|---|---|---|
| (m/min) | monoacid | diacid | monoacid | diacid | monoacid | diacid | monoacid | diacid |
| 4200 | 4.14 | 4.59 | 73.3 | 66.9 | 11.4 | 12.4 | 2989 | 3072 |
| 4800 | 4.15 | 4.69 | 68.7 | 62.2 | 13.0 | 14.3 | 2547 | 2616 |
| 5400 | 4.19 | 4.74 | 65.5 | 58.9 | 14.4 | 15.5 | 2214 | 2239 |
| 5800 | 4.04 | 4.69 | 57.9 | 55.1 | 16.8 | 17.3 | 1859 | 1993 |

TABLE 2
Mechanical properties BTT_ACA-monoacid FDY yarns

| | Titer | Tenacity | Elongation | E-modules | WTR |
|---|---|---|---|---|---|
| Draw Ratio | [dtex] | [cN/dtex] | [%] | [cN/dtex] | [cN, cm] |
| 1 | 73.6 | 4.14 | 73.3 | 11.4 | 2989 |
| 1.1 | 67.8 | 4.29 | 59.0 | 14.4 | 4959 |
| 1.2 | 64.3 | 4.53 | 50.5 | 13.2 | 4492 |
| 1.3 | 58.9 | 4.88 | 37.0 | 13.4 | 3419 |
| 1.4 | 55.3 | 5.29 | 29.3 | 14.7 | 2790 |

1. Process for the preparation of a polymer comprising the polymerisation of corresponding monomers in the presence of a triazine compound of the formula 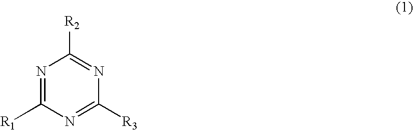
where R₁=-A-B
where
A=—O— or —NR4—,
B=amino group-containing substituent and
R₄=hydrogen or alkyl group
R₂= 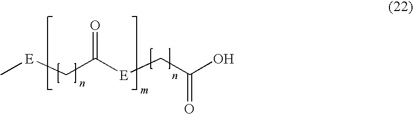
where
E=—O— or —NR₅—,
n=3 to 15,
in 0 to 10 and
R₅ hydrogen or alkyl group
R₃═R₁, R₂, —OR₆ or —NR₇R₉
where R₆, R₇ and R₈=hydrogen, alkyl or aryl group, which in each case may be substituted or non-substituted.

2. Process according to claim 1, wherein R₃ is a diamine rest group.

3. Process according to claim 1, wherein R₃ is an amino acid rest group.

4. Process according to claim 1, wherein the amount of the triazine compound with respect to the total of monomers and triazine compound is 2-70 mmoles/kg.

5. Process according to claim 1, wherein the polymer is a polyamide or a polyester.

6. Dyeable polymer characterized by the presence of a substituted triazine compound being chemically bonded to a polymer chain and having the formula I as defined in claim 1.

7. Polymer according to claim 6, wherein R₃ is a dianine rest group.

8. Polymer according to claim 6, wherein R₃ is an amino-acid rest group.

9. Polymer according to claim 6, wherein the polymer is a polyamide or a polyester.

10. Polymer fibre comprising as the polymer the polymer according to claim 6 or the polymer obtained with the process of any one of claims 1-5.

11. Object comprising the fibre according to claim 10.

12. Object according to claim 11, wherein the object is a piece of clothing or a floor covering.

13. UV stabilized polymer composition comprising a polyamide or polyester characterized by the presence of a substituted triazine compound having the formula I as defined in claim 1.
